(19) United States
(12) Patent Application Publication
(10) Pub. No.: US 2025/0030615 A1
(43) Pub. Date: Jan. 23, 2025

(54) SYSTEMS AND METHODS FOR NETWORK STATUS VISUALIZATION

(71) Applicant: VMWARE, INC., Palo Alto, CA (US)

(72) Inventors: VAIBHAV RUPESH KHAPARKAR, Pune (IN); Nilesh Arvind Ganu, Pune (IN); Shrinivas Sharad Parashar, Pune (IN); Pavan Krishna Vaidyula, Pune (IN)

(21) Appl. No.: 18/377,321

(22) Filed: Oct. 6, 2023

(30) Foreign Application Priority Data
Jul. 21, 2023 (IN) 202341049223

(51) Int. Cl. H04L 41/22; G06F 9/455; H04L 41/0631; H04L 43/045

(52) U.S. Cl. CPC H04L 41/22; G06F 9/45558; H04L 41/065; H04L 43/045

(57) ABSTRACT

Example methods and systems for network status visualization are described. In one example, a first computer system may generate and send a first query identifying a first-level object. Based on a first response, the first computer system may generate and display a first UI view that includes (a) a first user interface (UI) element and multiple second UI elements, (b) a first-level status indicator to indicate that the first-level object is associated with a performance issue, and (c) a second-level status indicator to indicate that the performance issue is associated with a particular second-level object. In response to detecting a user's interaction, the first computer system may generate and send a second query identifying the particular second-level object. Based on a second response, the first computer system may generate and display a second UI view to facilitate troubleshooting of the performance issue.

### RELATED APPLICATIONS

Benefit is claimed under 35 U.S.C. 119(a)-(d) to Foreign Application Serial No. 202341049223 filed in India entitled “SYSTEMS AND METHODS FOR NETWORK STATUS VISUALIZATION”, on Jul. 21, 2023, by VMware, Inc., which is herein incorporated in its entirety by reference for all purposes.

### BACKGROUND

Virtualization allows the abstraction and pooling of hardware resources to support virtual machines in a software-defined networking (SDN) environment, such as a software-defined data center (SDDC). For example, through server virtualization, virtual machines (VMs) running different operating systems may be supported by the same physical machine (also referred to as a “host”). Each VM is generally provisioned with virtual resources to run an operating system and applications. The virtual resources may include central processing unit (CPU) resources, memory resources, storage resources, network resources, etc. Through virtualization of networking services, logical network elements may be deployed to provide logical connectivity among VMs or other virtualized computing instances. In practice, it is desirable to provide a visualization of various entities in the SDDC to facilitate network diagnosis and troubleshooting.

### BRIEF DESCRIPTION OF DRAWINGS

FIG. 1 is a schematic diagram illustrating an example system architecture for network status visualization;

FIG. 2 is a schematic diagram illustrating an example software-defined networking (SDN) environment for which network status visualization may be performed;

FIG. 3 is a flowchart of an example process for a computer system to perform network status visualization;

FIG. 4 is a flowchart of an example detailed process for network status visualization;

FIG. 5 is a schematic diagram illustrating a first example user interface (UI) view in the form of a compute manager view;

FIG. 6 is a schematic diagram illustrating a second example UI view in the form of a cluster view;

FIG. 7 is a schematic diagram illustrating a third example UI view in the form of a sub-cluster view;

FIG. 8 is a schematic diagram illustrating a fourth example UI view in the form of a host view with packet flow information;

FIG. 9 is a schematic diagram illustrating a fifth example UI view in the form of a host view with packet flow information; and

FIG. 10 is a schematic diagram illustrating a sixth example UI view in the form of a host view with connectivity information.

### DETAILED DESCRIPTION

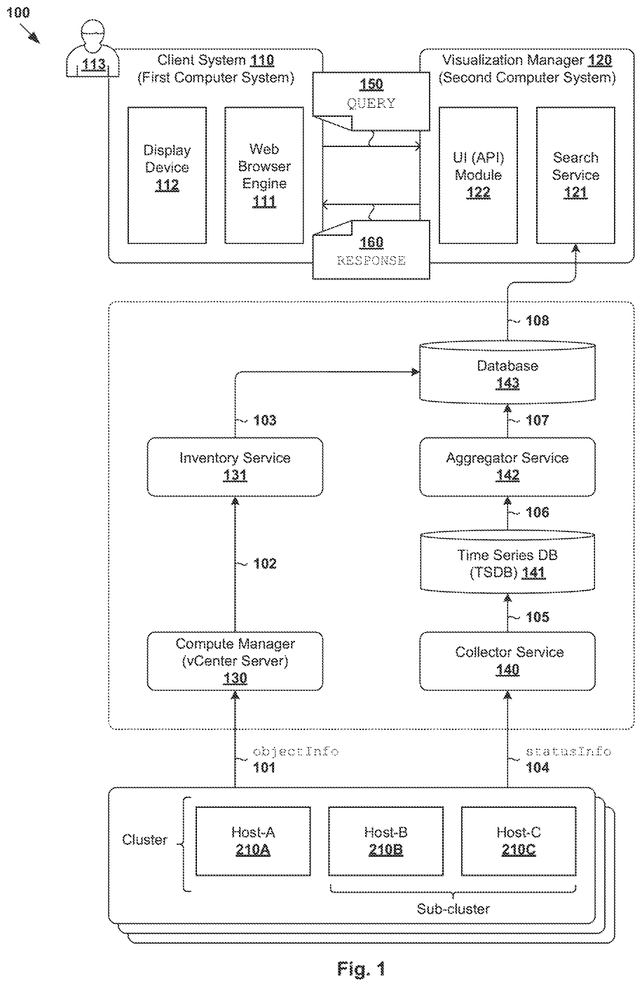

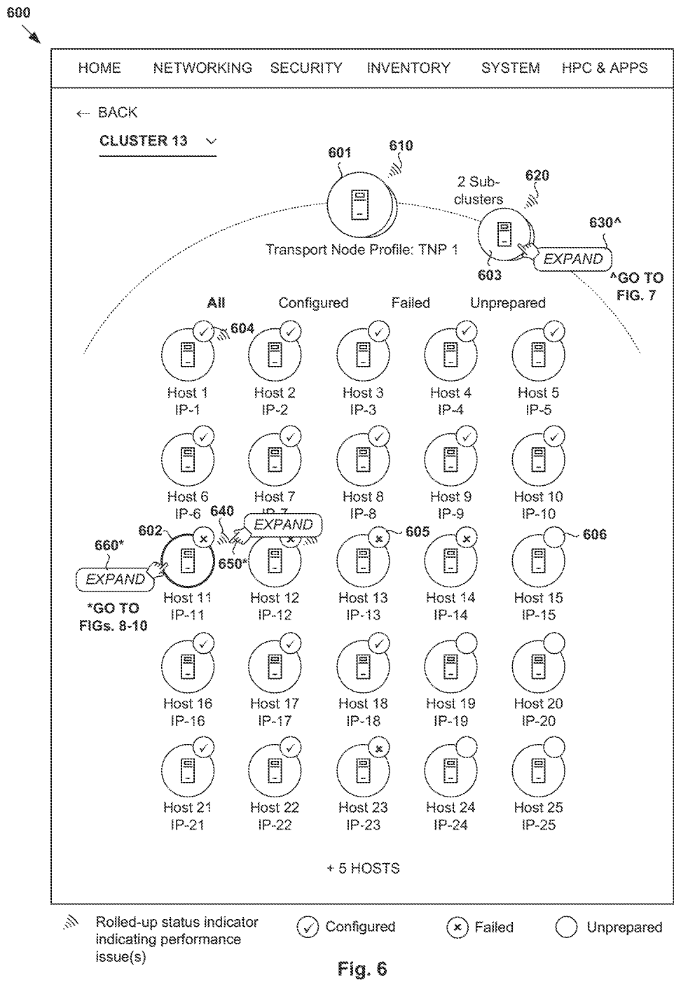

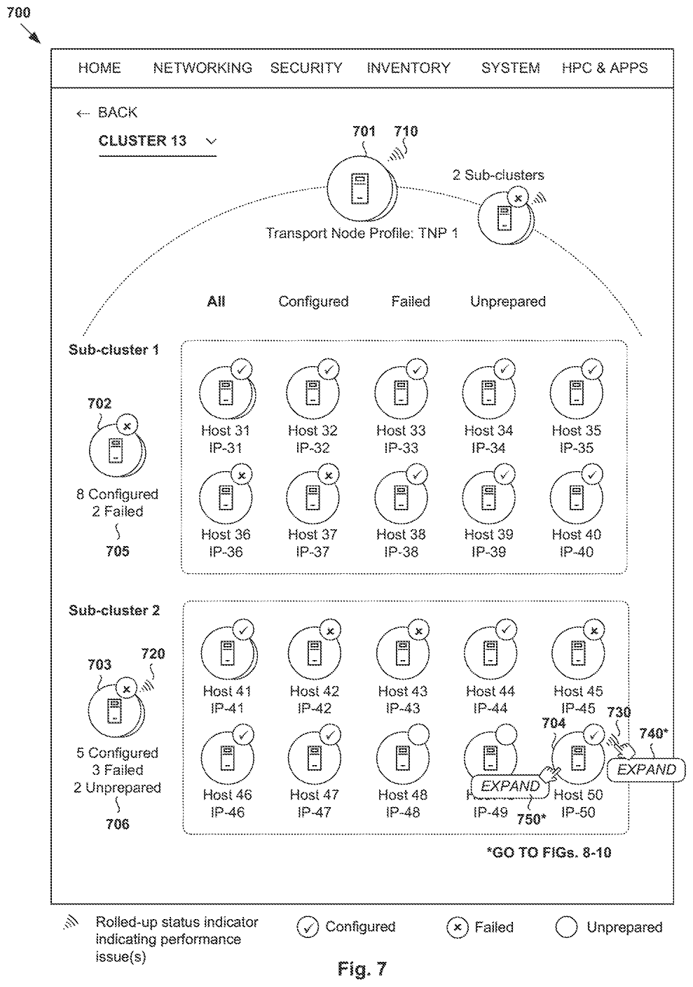

According to examples of the present disclosure, network status visualization may be performed in an improved manner to facilitate network troubleshooting. One example may involve a first computer system (e.g., client system 110 in FIG. 1) generating and sending a first query towards a second computer system (e.g., visualization manager 120 in FIG. 1). The first query may identify a first-level object (e.g., cluster) associated with multiple second-level objects (e.g., hosts within cluster). Based on a first response to the first query, the first computer system may generate and display a first UI view (e.g., see FIGS. 6-7) that includes: (a) a first UI element to represent the first-level object, and multiple second UI elements to represent respective multiple second-level objects, (b) a first-level status indicator to indicate that the first-level object is associated with a performance issue, and (c) a second-level status indicator to indicate that the performance issue is associated with a particular second-level from the multiple second-level objects.

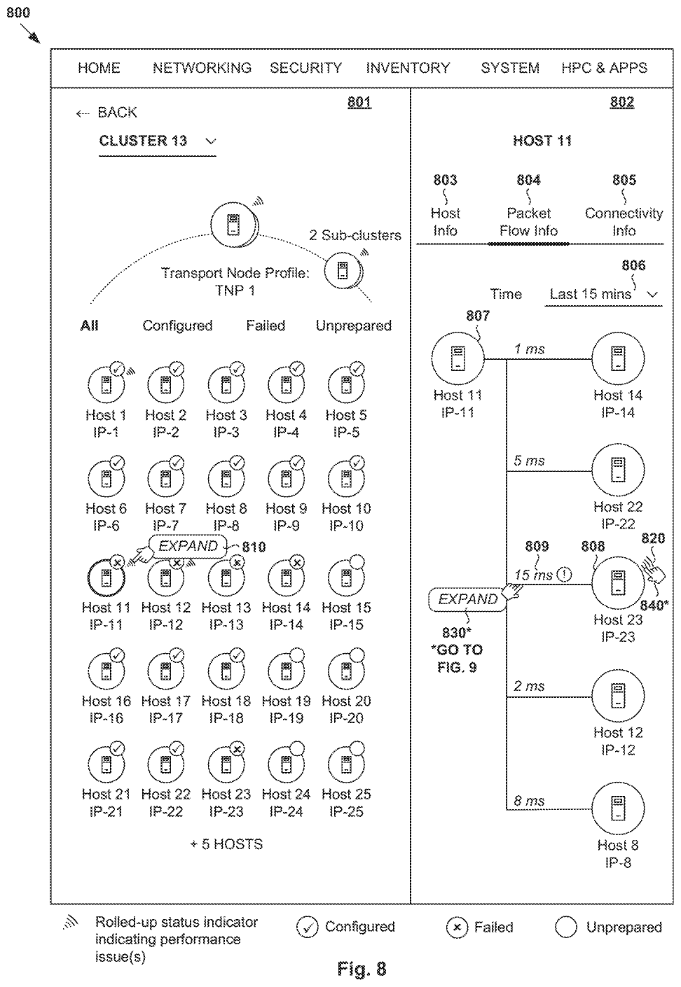

In response to detecting a user's interaction with the first-level status indicator, the second-level status indicator or a particular second UI element, the first computer system may generate and send a second query towards the second computer system. The second query may identify the particular second-level object associated with the performance issue. Based on a second response to the second query, the first computer system may generate and display a second UI view (e.g., see FIGS. 8-10) that includes information (e.g., packet flow information and/or connectivity information) associated with the performance issue to facilitate troubleshooting. The second UI view may also include multiple third-level UI elements representing respective multiple third-level objects, such as virtual machines (VM), virtual tunnel endpoints (VTEPs) or logical network elements, etc.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. For example, a first element may be referred to as a second element, and vice versa.

FIG. 1 is a schematic diagram illustrating example system architecture 100 to implement network status visualization for troubleshooting. It should be understood that, depending on the desired implementation, example system architecture 100 may include additional and/or alternative components than that shown in FIG. 1. Example system architecture 100 may include client system 110 (“first computer system”) and visualization manager 120 (“second computer system”) in communication with each other to implement network status visualization. Client system 110 may be operated by any suitable user 113, such as a network administrator responsible for network troubleshooting, etc.

Depending on the desired implementation, client system 110 and visualization manager 120 may each include any suitable hardware and/or software components. In the example in FIG. 1, visualization manager 120 may include user interface (UI) module 122 to interact with client system 110, search service 121 to handle queries from client system 110 and generate responses, etc. Client system 110 may include web browser engine 111 to interact with UI module 122 and generate graphical UI views, display device 112 to display UI views and detect interaction of user 113 with the UI element(s), etc. UI module 122 may facilitate interaction with client system 110 via any suitable interface(s), such as representational state transfer (REST) application programming interface (API), etc.

As used herein, the term “UI” or “UI view” may refer generally to a set of Ul elements that may be generated and displayed on a display device. The term “UI element” may refer generally to graphical (i.e., visual) and/or textual element that may be displayed on display device 112, such as shape (e.g., circle, rectangle, ellipse, polygon, line, etc.), window, pane, button, check box, menu, dropdown box, editable grid, section, slider, text box, text block, or any combination thereof. UI views may be displayed side by side, or nested inside of each other to create more complex layouts.

An example process for collecting information required to facilitate network status visualization will be explained using 101-108 in FIG. 1. Depending on the desired implementation, compute manager 130, inventory service 131, collector service 140, aggregator service 142 and search service 121 may be implemented using any suitable virtual and/or physical machine(s). In particular, at 101-102, compute manager 130 (e.g., vCenter server) may keep track of changes on managed inventory objects and update inventory service 132 accordingly. Here, the term “managed inventory object” (also referred to as “managed object” or “object”) may refer generally to a virtual or physical object in a network environment.

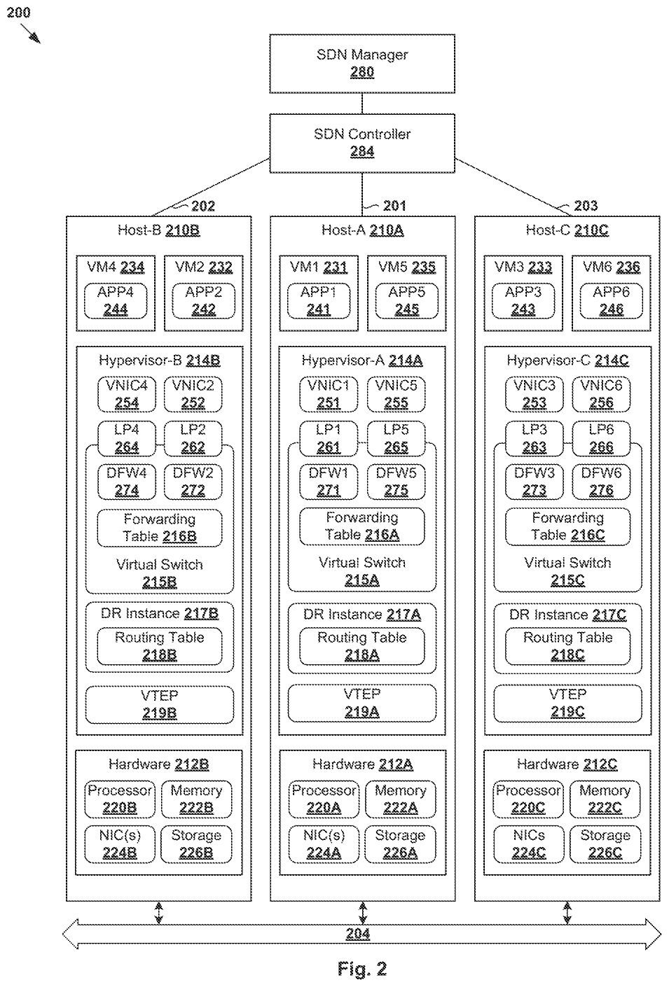

Example objects may include data centers, clusters, sub-clusters, hosts, virtualized computing instances, datastores, networks, resource pools, etc. A “cluster” may refer generally to a collection of hosts and associated VMs intended to work together as a unit. When a host is added to a cluster, the host's resources become part of the cluster's resources. A “sub-cluster” may refer generally to a subset of hosts within a cluster. A “host” or “transport node” may refer generally to a physical computer system supporting virtualized computing instances, such as virtual machines (VMs) or containers (to be explained using FIG. 2). At 103, inventory service 131 may save managed object information (denoted as objectInfo) in database 132, such as host/cluster/sub-cluster information.

Meanwhile, at 104 in FIG. 1, various hosts (e.g., hosts 210A-C) belonging to cluster(s) or sub-cluster(s) may collect status information (denoted as statusInfo) at any suitable sampling rate and push the status information to collector service 140. In practice, the status information may include metric information associated with packet flows (e.g., latency, packet loss, jitter, throughput), health information associated with component(s) supported by a host (e.g., whether a virtual tunnel endpoint (VTEP) is healthy or unhealthy), etc. For example, a host may start collecting metric information (e.g., latency) once a metric profile (e.g., latency profile) is applied on a particular host and physical network interface controller (PNIC) latency monitoring is enabled. At 105, collector service 140 may analyze status information collected by various hosts and decide on the next action(s), such as based on threshold(s) defined for packet flow metric(s). At 106, collector service 140 may then store the status information in a time series database (TSDB) 141. At 107, database 132 may store the status information, which is updated according to any change(s) in TSBD 141.

At 108 in FIG. 1, search service 121 may maintain indexed information and synchronized the indexed information with the information in database 132, including object information collected using compute manager 130 and status information collected using collector service 140. This way, based on the indexed information, search service 121 may handle queries (see 150) for any information required by client system 110 to generate/render UI views. In particular, based on a response (see 160) from search service 121, web browser engine 111 may generate and display UI views on display device 112 of client system 110.

In practice, web browser engine 111 may be capable of detecting a user's interaction on any UI element(s) on UI view(s) displayed on display device 112, such as mouse click(s), finger gesture(s) on a touch screen, etc. Web browser engine 111 may include a layout and rendering engine to render/generate/paint UI views on display device 112 based on response(s) from visualization manager 120, such as by interpreting hypertext transfer markup language (HTML) and/or extensible markup language (XML) documents along with images, etc. For example, web browser engine 111 may parse HTML documents and build a document object model (DOM) to represent content of a web page or UI view in a tree-like structure.

### Physical Implementation

FIG. 2 is a schematic diagram illustrating example network environment 200 for which network status visualization may be performed. Depending on the desired implementation, network environment 200 may include additional and/or alternative components than that shown in FIG. 1. Here, network environment 200 may be a software-defined networking (SDN) environment that includes multiple objects, including hosts 110A-C that are inter-connected via physical network 204. In practice, SDN environment 200 may include any number of hosts (also known as a “host computers”, “host devices”, “physical servers”, “server systems”, “transport nodes,” etc.), where each host may be supporting tens or hundreds of virtual machines (VMs).

Each host 210A/210B/210C may include suitable hardware 212A/212B/212C and virtualization software (e.g., hypervisor-A 214A, hypervisor-B 214B, hypervisor-C 214C) to support various VMs. For example, hosts 210A-C may support respective VMs 231-236 (see also FIG. 2). Hypervisor 214A/214B/214C maintains a mapping between underlying hardware 212A/212B/212C and virtual resources allocated to respective VMs. Hardware 212A/212B/212C includes suitable physical components, such as central processing unit(s) (CPU(s)) or processor(s) 220A/220B/220C; memory 222A/222B/222C; physical network interface controllers (NICs) 224A/224B/224C; and storage disk(s) 226A/226B/226C, etc.

Virtual resources are allocated to respective VMs 231-236 to support a guest operating system (OS) and application(s). For example, VMs 231-236 support respective applications 241-246 (see “APP1” to “APP6”). The virtual resources may include virtual CPU, guest physical memory, virtual disk, virtual network interface controller (VNIC), etc. Hardware resources may be emulated using virtual machine monitors (VMMs). For example in FIG. 2, VNICs 251-256 are virtual network adapters for VMs 231-236, respectively, and are emulated by corresponding VMMs (not shown for simplicity) instantiated by their respective hypervisor at respective host-A 210A, host-B 210B and host-C 210C. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

Although explained using VMs 231-236, it should be understood that SDN environment 200 may include other virtual workloads, such as containers, etc. As used herein, the term “container” (also known as “container instance”) is used generally to describe an application that is encapsulated with all its dependencies (e.g., binaries, libraries, etc.). For example, container technologies may be used to run various containers inside respective VMs 231-236. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

The term “hypervisor” may refer generally to a software layer or component that supports the execution of multiple virtualized computing instances, including system-level software in guest VMs that supports namespace containers such as Docker, etc. Hypervisors 214A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 214A/214B/214C implements virtual switch 215A/215B/215C and logical distributed router (DR) instance 217A/217B/217C to handle egress packets from, and ingress packets to, corresponding VMs. To protect VMs 231-236 against security threats caused by unwanted packets, hypervisors 214A-C may implement firewall engines to filter packets. For example, distributed firewall (DFW) engines 271-276 (see “DFW1” to “DFW6”) are configured to filter packets to, and from, respective VMs 231-236 according to firewall rules. In practice, network packets may be filtered according to firewall rules at any point along a datapath from a VM to corresponding physical NIC 224A/224B/224C. For example, a filter component (not shown) is incorporated into each VNIC 251-256 that enforces firewall rules that are associated with the endpoint corresponding to that VNIC and maintained by respective DFW engines 271-276.

Through virtualization of networking services in SDN environment 200, logical networks (also referred to as overlay networks or logical overlay networks) may be provisioned, changed, stored, deleted and restored programmatically without having to reconfigure the underlying physical hardware architecture. A logical overlay network may be formed using any suitable tunneling protocol, such as Virtual extensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts, which may reside on different layer 2 physical networks. Hypervisor 214A/214B/214C may implement virtual tunnel endpoint (VTEP) 219A/219B/219C to perform encapsulation and decapsulation for packets that are sent via a logical overlay tunnel that is established over physical network 204.

In practice, logical switches and logical routers may be deployed to form logical networks in a logical network environment. The logical switches and logical DRs may be implemented in a distributed manner and can span multiple hosts. For example, logical switches that provide first-hop, logical layer-2 connectivity (i.e., an overlay network) may be implemented collectively by virtual switches 215A-C and represented internally using forwarding tables 216A-C at respective virtual switches 215A-C. Forwarding tables 216A-C may each include entries that collectively implement the respective logical switches. VMs that are connected to the same logical switch are said to be deployed on the same logical layer-2 segment. Further, logical DRs that provide logical layer-3 connectivity may be implemented collectively by DR instances 217A-C and represented internally using routing tables 218A-C at respective DR instances 217A-C. Routing tables 218A-C may each include entries that collectively implement the respective logical DRs. As used herein, the term “logical network element” may refer generally to a logical switch, logical router, logical port, etc.

Packets may be received from, or sent to, each VM via an associated logical port. For example, logical switch ports 261-266 (see “LP1” to “LP6”) are associated with respective VMs 231-236. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 215A-C in FIG. 2, whereas a “virtual switch” may refer generally to a software switch or software implementation of a physical switch. In practice, there is usually a one-to-one mapping between a logical port on a logical switch and a virtual port on virtual switch 215A/215B/215C. However, the mapping may change in some scenarios, such as when the logical port is mapped to a different virtual port on a different virtual switch after migration of a corresponding virtualized computing instance (e.g., when the source host and destination host do not have a distributed virtual switch spanning them).

In a data center with multiple tenants requiring isolation from each other, a multi-tier topology may be used. For example, a two-tier topology includes an upper tier-0 (T0) associated with a provider logical router (PLR) and a lower tier-1 (T1) associated with a tenant logical router (TLR). The multi-tiered topology enables both the provider (e.g., data center owner) and tenant (e.g., data center tenant) to control their own services and policies. Each tenant has full control over its T1 policies, whereas common T0 policies may be applied to different tenants. A T0 logical router may be deployed at the edge of a geographical site to act as gateway between internal logical network and external networks, and also responsible for bridging different T1 logical routers associated with different data center tenants.

Further, a logical router may be a logical DR or logical service router (SR). A DR is deployed to provide routing services for VM(s) and implemented in a distributed manner in that it may span multiple hosts that support the VM(s). An SR is deployed to provide centralized stateful services, such as IP address assignment using dynamic host configuration protocol (DHCP), intrusion detection, load balancing, network address translation (NAT), etc. In practice, SRs may be implemented using edge appliance(s), which may be VM(s) and/or physical machines (i.e., bare metal machines). SRs are capable of performing functionalities of a switch, router, bridge, gateway, edge appliance, or any combination thereof. As such, a logical router may be one of the following: T1-DR, T1-SR (i.e., T1 gateway), T0-DR and T0-SR.

SDN manager 280 and SDN controller 284 are example network management entities that may be implemented using physical machine(s), VM(s), or both in SDN environment 200. One example of an SDN controller is the NSX controller component of VMware NSX® (available from VMware, Inc.). SDN controller 284 may be a member of a controller cluster (not shown for simplicity) that is configurable using SDN manager 280. For example, logical switches, logical routers, and logical overlay networks may be configured using SDN controller 284, SDN manager 280, etc. To send or receive control information, a local control plane (LCP) agent (not shown) on host 210A/210B/210C may interact with SDN controller 284 via control-plane channel 201/202/203 (shown in FIG. 2).

### Network Status Visualization

According to examples of the present disclosure, network status visualization may be performed in an improved manner to facilitate network diagnosis and troubleshooting. In the following, various examples will be described using multiple objects arranged in a hierarchy that includes multiple (L) levels, such as zero or root level (l=0), first level (l=1), second level (l=2), third level (l=3), and so on. A managed object associated with a particular level (l∈1, . . . , L) may be a member of an upper level. As used herein, the term “level” may refer generally to a group of members of another level. In practice, any suitable number of levels may be defined and any suitable object may be associated with for a particular level. One example may include: (a) zero- or root-level object=compute manager 130 capable of managing multiple objects, (b) first-level object=cluster/sub-cluster, (c) second-level object=host that is a member of a cluster/sub-cluster, (d) third-level object=VM, container, VTEP or logical network element supported by a particular host, etc.

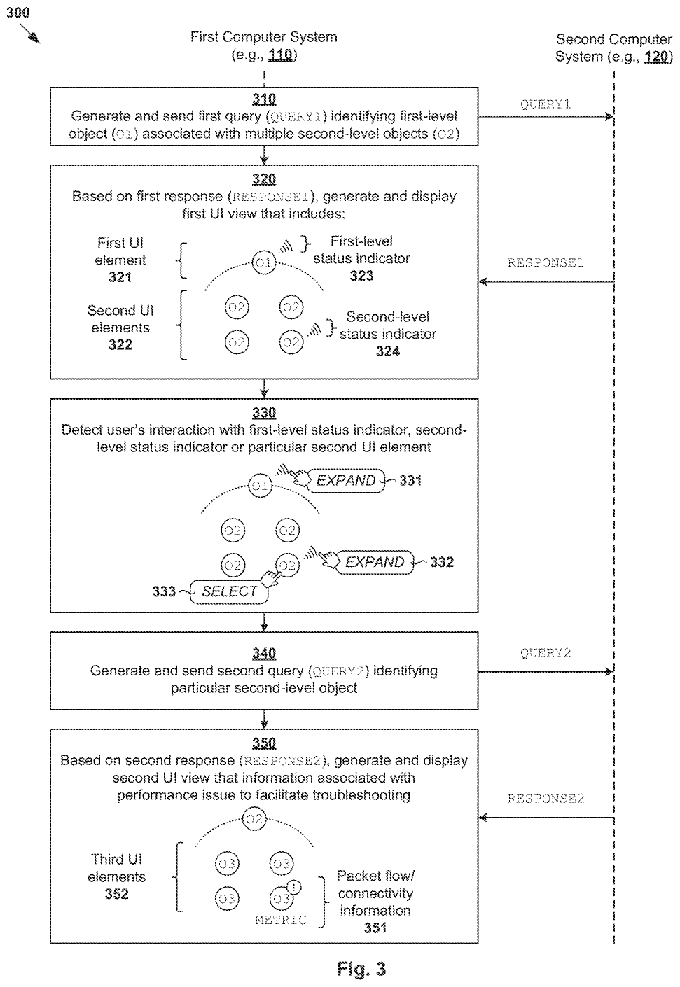

In more detail, FIG. 3 is a flowchart of example process 300 for a computer system to provide network status visualization. Example process 300 may include one or more operations, functions, or actions illustrated by one or more blocks, such as 310 to 350. The various blocks may be combined into fewer blocks, divided into additional blocks, and/or eliminated depending on the desired implementation. Examples of the present disclosure may be performed using any suitable computer system(s) that include hardware and/or software components configured to provide network status visualization. Example process 300 may be implemented using client system 110 as a first computer system, and visualization manager 120 as a second computer system.

At 310 in FIG. 3, client system 110 may generate and send a first query (QUERY1) towards visualization manager 120. The first query may identify a first-level object (denoted as O1) associated with multiple second-level objects (denoted as O2). In one example, a cluster or sub-cluster may be the “first-level object,” and multiple hosts within the cluster or sub-cluster the “second-level objects.”

At 320 in FIG. 3, based on a first response (RESPONSE1) to the first query (QUERY1), client system 110 may generate and display a first UI view that includes (a) a first UI element and multiple second UI elements arranged in a hierarchy (also known as an umbrella view), (b) a first-level status indicator and (c) a second-level status indicator. In particular, the first UI element (see 321) may represent the first-level object, and the multiple second UI elements (see 322) represent the respective multiple second-level objects. The first-level status indicator (see 323) may indicate that the first-level object is associated with a performance issue. The second-level status indicator (see 324) may indicate that the performance issue is associated with a particular second-level object from the multiple second-level objects.

In practice, the “status indicator” (also known as a “rolled-up status indicator”) may be presented using visual and/or textual UI element(s) to facilitate more efficient identification and troubleshooting of a particular performance issue. For example, in response to detecting a performance issue associated with at least one third-level object (i.e., grandchild object), a second-level status indicator may be displayed for a second-level object (i.e., child object) to indicate the performance issue. The “rolling up” or status propagation may continue by displaying the first-level status indicator to indicate the performance issue is associated with a first-level object, which is a parent object of the second-level object. In other words, a rolled-up status indicator may be displayed for a parent object that has issues with their child and/or grandchild object(s). For example, if VMs 231-232 on host-A 110A are experiencing latency-related performance issue, the status indicator may be rolled-up to a host, then a cluster or sub-cluster, and finally to a compute manager.

At 330-340 in FIG. 3, in response to detecting a user's interaction with the first-level status indicator (see 331), the second-level status indicator (see 332) or a particular second UI element (see 333) representing the particular second-level object, client system 110 may generate and send a second query (QUERY2) towards visualization manager 120. The second query may identify the particular second-level object associated with the performance issue.

At 350 in FIG. 3, based on a second response (RESPONSE2) to the second query, client system 110 may generate and display a second UI view that includes information associated with the performance issue (see 351), such as packet flow information, connectivity information, etc. In one example, the second UI view may include multiple third-level UI elements (see 352) may represent respective multiple third-level objects associated with the particular second-level object to facilitate troubleshooting of the performance issue. The performance issue may be associated with at least one of the multiple third-level objects.

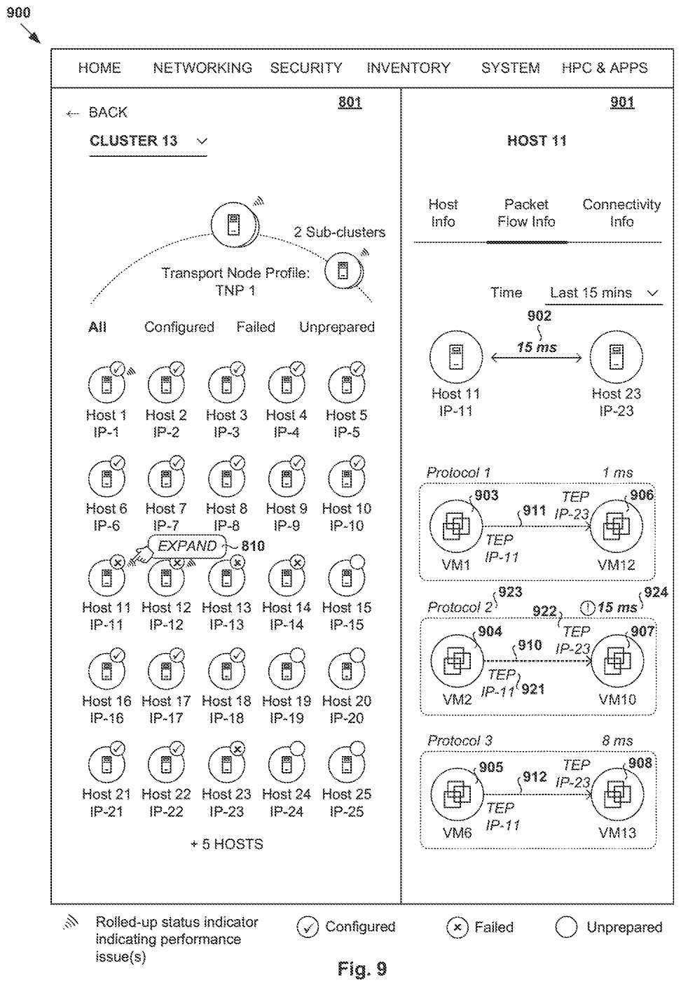

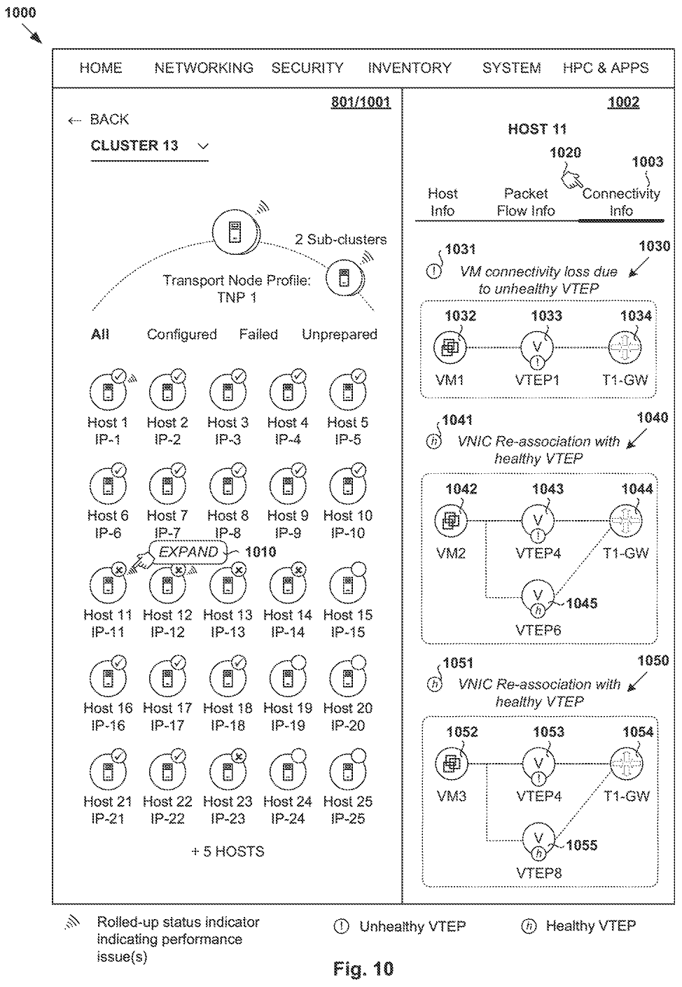

In a first example (see FIGS. 8-9), the second UI view may include packet flow information identifying the performance issue in the form of one of the following packet flow metrics not satisfying a threshold: latency, jitter, packet loss and throughput. In a second example (see FIG. 10), the second UI view may include connectivity information identifying the performance issue in the form of a connectivity loss caused by an unhealthy VTEP supported by a particular host. For example in FIG. 2, it is important to monitor VTEP health because any performance issue associated with VTEP 219A/219B/219C may result in loss of connectivity and functionality provided by VMs 231-236. Other example performance issues may be associated with a logical network element (e.g., logical switch or logical router), hardware failure, software failure, logical and/or physical network failure, etc. The performance issue(s) of interest may be configurable by user 113.

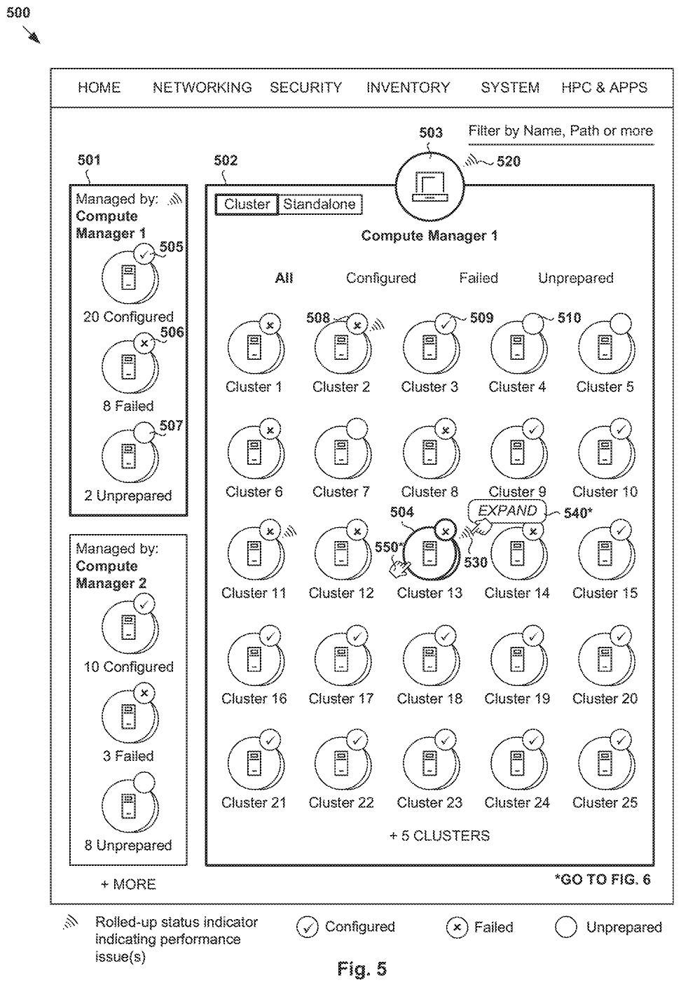

From a monitoring and troubleshooting perspective, it is important for user 113 to locate faulty object(s) affected by performance issue(s) quickly and easily, and to facilitate further exploration on the performance issue(s). Examples of the present disclosure may be implemented to generate and display a compute manager view (see FIG. 5), a cluster view (see FIG. 6), a sub-cluster view (see FIG. 7) and a host view (see FIGS. 8-10) with rolled-up status indicator(s) at each level of the object hierarchy. These UI views will help user 113 to quickly drill down from a compute manager to a host with performance issue(s). As SDN environment 200 increases in scale and complexity, any improvement in network status visualization may facilitate improved network troubleshooting and diagnosis.

Further, examples of the present disclosure may be implemented to provide UI views (known as umbrella views) that each include UI elements arranged in a hierarchy to represent objects of different levels. The umbrella view may provide improved clarity on host membership, thereby helping user 113 to quickly identify the parent cluster or sub-cluster of a particular host as well as other hosts within the same cluster or sub-cluster. This way, the hierarchy of clusters, sub-clusters and hosts may be presented in a clearer and more organized manner. Examples of the present disclosure should be contrasted against conventional approaches that rely on the usual table or grid view, which is only able to display a limited number of objects (e.g., hosts) and requires user 113 to scroll down to see more. Also, in the absence of any rolled-up status indicators, it is generally cumbersome for user 113 to identify faulty object(s) using the table or grid view, which is inefficient and undesirable.

### Compute Manager View (See FIG. 5)

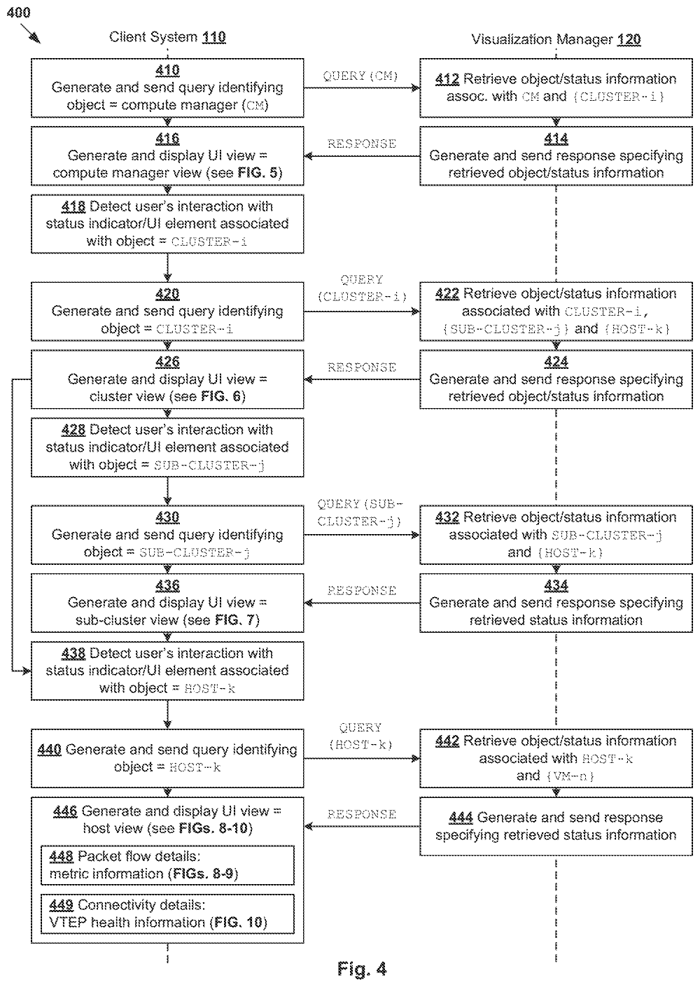

Some example UI views will be explained using FIG. 4, which is a flowchart of example detailed process 400 for network status visualization. Example process 400 may include one or more operations, functions, or actions illustrated by one or more blocks, such as 410 to 449. The various blocks may be combined into fewer blocks, divided into additional blocks, and/or eliminated depending on the desired implementation. In the following, client system 110 (e.g., web browser engine 111) may generate and send queries towards search service 121 via UI module 122 on visualization manager 120.

At 410 in FIG. 4, client system 110 may generate and send a query identifying a particular root-level object=compute manager (denoted as CM) to visualization manager 120. At 412, in response to receiving the query, visualization manager 120 may retrieve object and/or status information associated with CM and a set of multiple clusters (denoted as {CLUSTER-i}) managed by CM. Each cluster (CLUSTER-i) may represent a first-level object that is a child of the root-level object. As used herein, the “object information” may refer generally to a set of attributes or properties associated with a particular object, including its relationship with parent object(s) and/or child object(s). For a compute manager, the object information (i.e., compute manager and cluster information) may identify a set of clusters under the management of the compute manager. The “status information” may refer generally to any information based on which performance issue(s) may be detected, such as metric information associated with packet flows, VTEP health information, etc.

At 414, visualization manager 120 may generate and send a response specifying the retrieved information to client system 110. At 416, based on the response, client system 110 may generate and display UI view=compute manager view on display device 112 based on a response specifying the object and/or status information. At 418, in response to detecting a user's interaction with status indicator or UI element associated with a particular CLUSTER-i, client system 110 may perform block 420 below.

FIG. 5 is a schematic diagram illustrating first example UI view 500 in the form of a compute manager view. Here, compute manager view 500 may include a left pane (see 501) showing multiple compute managers that are registered, and a right pane (see 502) showing a set of multiple clusters denoted as {CLUSTER-i} managed by a particular compute manager. Right pane 502 may be generated and displayed on display device 112 in response to detecting a user's selection of “Compute Manager 1” on left pane 501. Right pane 502 may include a first UI element (see 503) representing “Compute Manager 1” and multiple second UI elements (e.g., see 504) representing the set of multiple clusters. Note that not all UI elements are assigned with a reference numeral for simplicity. Second UI elements representing respective “Cluster 1” to “Cluster 25” may be arranged in an array under first UI element 503 to indicate that they are child objects of “Compute Manager 1.”

For each compute manager, left pane 501 may include UI elements 505-507 indicating the number of member clusters associated with host-level status=configured (see 505), failed (see 506) or unprepared (see 507). Status=“configured” may mean that a particular object (i.e., cluster in FIG. 5) has been configured with a transport node profile. Status=“unprepared” may mean that a particular object has not been configured with a transport node profile. Status=“failed” may mean that a particular object has been configured but failed. In practice, the “failed” status may represent a runtime or operational status reported at the host level. Possible causes failed status may include one or more of the following: host's connectivity to SDN controller and/or SDN manager (e.g., 280-284 in FIG. 2) may be down, host is unreachable and having a disconnected status, or tunnels on the host may be down.

The host-level runtime or operational status (i.e., configured, failed or unprepared) may be rolled up or propagated to the cluster level (see 508), sub-cluster level (see FIG. 7) and compute manager level (see 506). For each cluster under a selected compute manager, right pane 502 may include UI elements (e.g., 508-510) indicating whether the cluster is associated with status=configured (see 508), failed (see 509) or unprepared (see 510) based on the status of host(s) within the cluster. For example, if at least one host within a cluster or sub-cluster is associated with status=failed (or unprepared), then the cluster or sub-cluster is also associated with status=failed (or unprepared. In practice, the status may be indicated using symbols (e.g., tick for “configured,” cross for “failed” and none for “unprepared” as shown in FIG. 5), colors (e.g., green for “configured,” red for “failed” and yellow for “unprepared”), etc.

In practice, a transport node profile (TNP) may represent a configuration (e.g., IP address pools) that is applied to a host cluster, such as to configure networking and security features on host(s) in that cluster. In practice, there may be a stretched cluster use case where a cluster may include hosts that are from different racks in the data center and therefore connected to different top of rack (ToR) switches. In this case, the hosts may be associated with different layer-3 domains or IP address pools. Having a single common TNP may not suffice for the stretched cluster use case. To support the stretched cluster use case, hosts within the cluster may be grouped together to form sub-clusters. The grouping may be based on layer-3 domain. The TNP may include zero or more sub-configurations (with different IP address pool configurations) called sub-TNP configuration. As such, while applying TNP on a cluster, user 113 may choose a certain sub-TNP configuration for each sub-cluster.

Compute manager view 500 may further include status indicators indicating a performance issue, such as a manager-level status indicator (see 520) associated with “Compute Manager 1” and a cluster-level status indicator (se 530) associated with a particular CLUSTER-i. Note that manager-level status indicator 520 may be displayed in response to determination that at least one CLUSTER-i is associated with a performance issue. Similarly, cluster-level status indicator 530 may be displayed in response to determination that at least one SUB-CLUSTER-j or HOST-k within that CLUSTER-i is associated with the performance issue. To facilitate troubleshooting of the performance issue, client system 110 may detect a user's interaction (see 540) with status indicator 520/530 or UI element representing CLUSTER-i (see 550) on compute manager view 500 to cause the generation and display of a cluster view in FIG. 6.

### Cluster View (See FIG. 6)

Referring to FIG. 4 again, at 420, client system 110 may generate and send a query identifying a particular first-level object=cluster (CLUSTER-i) to visualization manager 120. At 422, in response to receiving the query, visualization manager 120 may retrieve object and/or status information associated with members of CLUSTER-i, i.e., a set of multiple sub-clusters denoted as {SUB-CLUSTER-j} and a set of multiple hosts denoted as {HOST-k} within CLUSTER-i. A particular sub-cluster (SUB-CLUSTER-j) or host (HOST-k) may represent a second-level object that is a child of the first-level object.

At 424, visualization manager 120 may generate and send a response specifying the retrieved information to client system 110. At 426, based on the response, client system 110 may generate and display UI view=cluster view. For CLUSTER-i, the object information (i.e., cluster information) may identify its responsible compute manager, as well as host(s) and sub-cluster(s) within CLUSTER-i. At 428, in response to detecting a user's interaction with status indicator or UI element associated with a particular SUB-CLUSTER-j, client system 110 may perform block 430 below to generate and display a sub-cluster view. Alternatively, at 438, in response to detecting a user's interaction with status indicator(s) or UI element(s) associated with a particular HOST-k, client system 110 may perform block 440 to generate and display a host view.

FIG. 6 is a schematic diagram illustrating second example UI view 600 in the form of a cluster view. In the example in FIG. 6, cluster view 600 may provide a graphical umbrella view for user 113 to view all sub-cluster(s) and host(s) in a particular cluster (CLUSTER-i) that is selected using compute manager view 500. Cluster view 600 may include a first UI element (see 601) representing selected CLUSTER-i (e.g., i=13), and multiple second UI elements (see 602-603) representing respective members of CLUSTER-i, including hosts and sub-clusters. Second UI elements (e.g., 602) representing respective “Host 1” to “Host 25” may be arranged in an array under first UI element 601 to indicate that they are child objects of “Cluster 13” at a single glance. Second UI element 603 may indicate that there are two further child objects (i.e., “2 Sub-clusters”) within “Cluster 13” at a single glance. Cluster view 600 may indicate the status associated with each host (HOST-k), such as configured (see 604), failed (see 605) or unprepared (see 606).

To facilitate troubleshooting, cluster view 600 may include cluster-level status indicator 610 indicating that CLUSTER-i (e.g., i=13) is associated with a performance issue in response to determination that at least one member is associated with the performance issue. In one example, cluster view 600 may include sub-cluster-level status indicator 620 to indicate that SUB-CLUSTER-j is associated with the performance issue. In this case, client system 110 may detect user 113 interacting with (see 630) second UI element 603 representing SUB-CLUSTER-j or sub-cluster-level status indicator 620 to cause the generation and display of a sub-cluster view in FIG. 7.

In another example, cluster view 600 may include host-level status indicator 640 to indicate that HOST-k is associated with the performance issue. In this case, client system 110 may detect user 113 interacting with (see 650/660) second UI element 602 representing HOST-k or host-level status indicator 640 to cause the generation and display of a host view in FIGS. 8-10.

### Sub-Cluster View (See FIG. 7)

Referring to FIG. 4 again, at 430, in response to detecting the user's interaction at block 428, client system 110 may generate and send a query identifying a particular object=sub-cluster (SUB-CLUSTER-j) to visualization manager 120. At 432, in response to receiving the query, visualization manager 120 may retrieve object and/or status information associated with members of SUB-CLUSTER-j, i.e., a set of multiple hosts (denoted as HOST-k) within SUB-CLUSTER-j. In this case, each host (HOST-k) may represent a third-level object, i.e., child of the second-level object.

At 434 in FIG. 4, visualization manager 120 may generate and send a response specifying the retrieved information to client system 110. At 436, based on the response, client system 110 may generate and display UI view=sub-cluster view based on a response specifying the object and/or status information. For SUB-CLUSTER-j, the object information (i.e., sub-cluster information) may identify which cluster it belongs to, as well as host(s) within SUB-CLUSTER-j. At 438, in response to detecting a user's interaction with status indicator(s) or UI element(s) associated with a particular HOST-k, client system 110 may perform block 440 below.

FIG. 7 is a schematic diagram illustrating third example UI view 700 in the form of a sub-cluster view. In the example in FIG. 7, sub-cluster view 700 may provide a graphical umbrella view for user 113 to view various sub-clusters within a cluster at a single glance. For example, CLUSTER-13 may include two sub-clusters that each include multiple hosts. Sub-cluster view 700 may include a first UI element (see 701) representing selected CLUSTER-i (e.g., i=13), and second UI elements (see 702-703) representing two sub-clusters indicated at 603 in FIG. 6. Sub-cluster view 700 may indicate the status of each SUB-CLUSTER-j based on the status of its member hosts, such as configured, failed or unprepared.

To facilitate troubleshooting, sub-cluster view 700 in FIG. 7 may include cluster-level status indicator 710 indicating that CLUSTER-i (e.g., i=13) is associated with a performance issue in response to determination that at least one member sub-cluster or host is associated with the performance issue. For example, sub-cluster view 700 may include sub-cluster-level status indicator 720 indicating that SUB-CLUSTER-j (e.g., j=2) is associated with the performance issue. Host-level status indicator 730 on sub-cluster view 700 is to indicate that at least one host in that sub-cluster is associated with the performance issue, such as HOST-k (e.g., k=50). In this case, client system 110 may detect user 113 interacting with (see 740/750) second UI element 704 representing HOST-k or host-level status indicator 730 to cause the generation and display of a host view in FIGS. 8-10.

### Host Views (See FIGS. 8-10)

Referring to FIG. 4 again, at 440, in response to detecting the user's interaction at block 428, client system 110 may generate and send a query identifying a particular object=host (HOST-k) to visualization manager 120. At 442, in response to receiving the query, visualization manager 120 may retrieve object and/or status information associated with a set of multiple VMs (denoted as {VM-n}) or VTEPs (not shown) supported by HOST-k.

At 444, visualization manager 120 may generate and send a response specifying the retrieved information to client system 110. For HOST-k, the object information (i.e., host information) may identify the VMs and/or VTEPs (i.e., third-level objects) supported by that host. At 446, based on the response from visualization manager 120, client system 110 may generate and display UI view=host view to facilitate troubleshooting of performance issue(s) affecting one or more VMs on a host. Some example host views will be discussed below using FIGS. 8-10.

### (a) Packet Flow Information

In a first example (see 448 and FIGS. 8-9), the host view generated at block 446 may include packet flow information for user 113 to debug performance issue(s) relating to packet flow(s), such as latency, packet loss, jitter, throughput, etc. For example, FIG. 8 is a schematic diagram illustrating fourth example UI view 800 in the form of a host view with packet flow information. FIG. 9 is a schematic diagram illustrating fifth example UI view 900 in the form of a host view with packet flow information.

Referring first to FIG. 8, example UI view 800 may include left pane 801 to display cluster view 600 in FIG. 6, which includes UI elements representing hosts within a particular cluster. In response to detecting a user's selection of a particular HOST-k on left pane 801, client system 110 may generate right pane 802 (i.e., host view) to display information associated with HOST-k, such as host information tab (see 803), packet flow information tab (see 804), and connectivity information tab (see 805). In response to detecting a user's selection of packet flow information tab 804, client system 110 may generate and display metric information (e.g., latency) associated with packet flows between HOST-k and other host(s). A predetermined time frame (e.g., last 15 minutes; see 806) may be specified to display metric information associated with packet flow(s) detected within the time frame.

For example, host view 802 in FIG. 8 may include various UI elements (see 807-809) to represent selected HOST-k (e.g., host-11), a remote host (e.g., host-23) and metric information (e.g., latency) associated with packet flow(s) between the pair of hosts. Host view 802 may further include rolled-up status indicator 820 to indicate a latency issue is associated with the packet flow(s) to/from a particular host. In response to detecting a user's interaction (see 830-840) with rolled-up status indicator 820 or UI element (e.g., line) representing path(s) or packet flow(s) between a pair of hosts, client system 110 may generate and display updated UI view 900 in FIG. 9.

Referring now to FIG. 9, example UI view 900 may include the same cluster view on left pane 801 in FIG. 8, and updated host view 901 to display more granular details about packet flow(s) between a pair of hosts, including latency issue (see 902). Client system 110 may generate updated host view 901 to include UI elements representing various VMs (see 903-905) and packet flows (see 910-912). For example, details about three packet flows between host-11 and host-23 are shown, including a first packet flow between VM1 and VM12 using a first protocol, a second packet flow between VM2 and VM10 using a second protocol, and a third packet flow between VM6 and VM13 using a third protocol.

For each pair of VMs (e.g., VM2 on host-11 and VM10 on host-23), client system 110 may generate updated host view 901 to further include UI elements describing packet flow(s) between them, TEP information (see 921-922), protocol information (see 923) and latency information (see 924). For example, to facilitate debugging, updated host view 901 indicates a latency issue is associated with the second packet flow, such as by highlighting the second packet flow and/or latency information in red (i.e., threshold exceeded). Other packet flows that do not have any latency issue may be highlighted in green.

In practice, latency information may be measured using any suitable approach. For example, a latency profile specifying a sampling rate and a flag (e.g., PNIC_LATENCY_ENABLED) may be applied on a host to cause the host to report latency information to collector service 140. The latency information may be associated with one or more of the following: PNIC to VNIC, VNIC to PNIC, VNIC to VNIC, PNIC to PNIC and VTEP to VTEP for overlay networking. Depending on the sampling rate, each entry of latency information may include (first endpoint, second endpoint, maximum latency value, minimum latency value, average latency value). Here, the “endpoint” may represent a virtual interface ID or a PNIC name. The latency values may be in microseconds, for example.

In response to receiving the latency information from various hosts, collector service 140 may analyze the latency information based on predetermined thresholds. Once the thresholds are exceeded, the relevant packet flow(s), VM(s) and host(s) may be marked or flagged as having performance (i.e., latency) issues. This status indicating the performance issue may be propagated from the VM level to the host level, cluster/sub-cluster level and then compute manager level. Any additional and/or alternative metric information may be used, such as packet loss, jitter, throughput, etc.

### (b) Connectivity Information

In a second example (see 449 and FIG. 10), the host view generated at block 446 may include connectivity information for user 113 to debug performance issue(s) relating to network connectivity, such as loss of connectivity caused by unhealthy VTEP(s), etc. Blocks 446 and 449 will be described using FIG. 10, which is a schematic diagram illustrating sixth example UI view 1000 in the form of a host view with connectivity information. Example UI view 1000 may include the same cluster view on left pane 801/1001 in FIG. 8, and a host view on right pane 1002 to display more granular details about network connectivity, such as VTEP health information and VM(s) experiencing connectivity loss due to unhealthy VTEP. Host view 1002 may be generated and displayed in response to detecting a user's selection (see 1010-1020) of a particular HOST-k and connectivity information tab 1003.

Host view 1002 may include UI elements representing VM(s), VTEP(s), logical network element(s) such as a remote tier-1 gateway, and connectivity information. At 1030, host view 1002 may include a first VTEP health indicator (see 1031) to indicate that VM1 (see 1032) on host-11 has lost connectivity with a tier-1 gateway (see 1034) due to an unhealthy VTEP=VTEP1 (see 1033). Depending on the desired implementation, any suitable colors (e.g., red=unhealthy and green=healthy), symbols (e.g., “!”=unhealthy and “h”=healthy in FIG. 10) or shapes may be used to indicate whether a VTEP is healthy or unhealthy.

At 1040, host view 1002 may include a second indicator (see 1041; “h”=healthy) to indicate that VM2 (see 1042) has connectivity with the tier-1 gateway (see 1044) by successfully re-associating with a healthy VTEP=VTEP6 (see 1045) after losing connectivity due to an unhealthy VTEP=VTEP4 (see 1043). At 1050, host view 1002 may include a second indicator (see 1051; “h”=healthy) to indicate that VM3 (see 1052) has connectivity with the tier-1 gateway (see 1054) by successfully re-associating with a healthy VTEP=VTEP8 (see 1055) after losing connectivity due to an unhealthy VTEP=VTEP4 (see 1053).

Using examples of the present disclosure, host view 1002 with connectivity information may allow user 113 to identify connectivity issue(s) caused by unhealthy VTEP(s). This way, user 113 may perform remediation action(s) to address the connectivity issue(s), such as by enabling a high availability (HA) feature to cause automatic VNIC re-association with a healthy VTEP (see 1030-1040) in the event of a failure. In practice, any suitable approach may be implemented to enable the HA feature for VTEP(s) on HOST-k.

One example may involve configuring HOST-k with a particular profile (e.g., “VTEPHAHostSwitchProfile”) and an auto-recovery feature. After performing the configuration, an alarm may be raised in the event of a VTEP failure. The alarm may include any suitable information associated with the failed VTEP, such as VTEP name (e.g., VM kernel NIC (vmKNIC) name), VTEP state, distributed virtual switch (DVS) name, transport node ID associated with HOST-k, VTEP failure reason, etc. Based on the alarm, HOST-k may be identified to have a performance issue in the form of a faulty VTEP. Once the faulty VTEP is encountered, auto-recovery operation(s) may be triggered to re-associate with a healthy VTEP.

### Computer System

The above examples can be implemented by hardware (including hardware logic circuitry), software or firmware or a combination thereof. The above examples may be implemented by any suitable computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 10.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

What is claimed is:

1. A method for a first computer system to provide network status visualization, wherein the method comprises:
generating and sending, towards a second computer system, a first query identifying a first-level object;
based on a first response to the first query, generating and displaying a first user interface (UI) view that includes:
(a) a first UI element to represent the first-level object, and multiple second UI elements to represent respective multiple second-level objects associated with the first-level object;
(b) a first-level status indicator to indicate that the first-level object is associated with a performance issue; and
(c) a second-level status indicator to indicate that the performance issue is associated with at least a particular second-level object from the multiple second-level objects; and
in response to detecting a user's interaction with the first-level status indicator, the second-level status indicator or a particular second UI element representing the particular second-level object,
generating and sending, towards the second computer system, a second query identifying the particular second-level object; and
based on a second response to the second query, generating and displaying a second UI view that includes information identifying the performance issue associated with the particular second-level object to facilitate troubleshooting.

2. The method of claim 1, wherein generating and displaying the first UI view comprises:
generating and displaying the first UI view that includes the first UI element and the multiple second UI elements arranged in a hierarchy, wherein (a) the first UI element represents a cluster or sub-cluster, being the first-level object, and (b) the multiple second UI elements represent respective multiple hosts, being the multiple second-level objects, in the cluster or sub-cluster.

3. The method of claim 1, wherein generating and displaying the second UI view comprises:
generating and displaying the second UI view that includes multiple third UI elements representing respective multiple third-level objects associated with the particular second-level object, wherein the performance issue is associated with at least one of the multiple third-level objects.

4. The method of claim 3, wherein generating and displaying the second UI view comprises:
generating and displaying the second UI view that includes multiple third UI elements representing the respective multiple third-level objects, wherein the multiple third-level objects include one of the following: a virtualized computing instance, a virtual tunnel endpoint (VTEP) and a logical network element.

5. The method of claim 1, wherein generating and displaying the second UI view comprises:
generating and displaying the second UI view that includes packet flow information identifying the performance issue in the form of one of the following packet flow metrics not satisfying a threshold: latency, jitter, packet loss and throughput.

6. The method of claim 1, wherein generating and displaying the second UI view comprises:
generating and displaying the second UI view that includes connectivity information identifying the performance issue in the form of a connectivity loss caused by an unhealthy VTEP supported by a particular host, being the particular second-level object.

7. The method of claim 1, wherein the method further comprises:
prior to generating and displaying the first UI view, generating and displaying a prior UI view that includes a zero-level status indicator indicating that a root-level object is associated with the performance issue based on the first-level object and the particular second-level object being associated with the performance issue.

8. A non-transitory computer-readable storage medium that includes a set of instructions which, in response to execution by a processor of a first computer system, cause the processor to perform a method of network status visualization, wherein the method comprises:
generating and sending, towards a second computer system, a first query identifying a first-level object;
based on a first response to the first query, generating and displaying a first user interface (UI) view that includes:
(a) a first UI element to represent the first-level object, and multiple second UI elements to represent respective multiple second-level objects associated with the first-level object;
(b) a first-level status indicator to indicate that the first-level object is associated with a performance issue; and
(c) a second-level status indicator to indicate that the performance issue is associated with at least a particular second-level object from the multiple second-level objects; and
in response to detecting a user's interaction with the first-level status indicator, the second-level status indicator or a particular second UI element representing the particular second-level object,
generating and sending, towards the second computer system, a second query identifying the particular second-level object; and
based on a second response to the second query, generating and displaying a second UI view that includes information identifying the performance issue associated with the particular second-level object to facilitate troubleshooting.

9. The non-transitory computer-readable storage medium of claim 8, wherein generating and displaying the first UI view comprises:
generating and displaying the first UI view that includes the first UI element and the multiple second UI elements arranged in a hierarchy, wherein (a) the first UI element represents a cluster or sub-cluster, being the first-level object, and (b) the multiple second UI elements represent respective multiple hosts, being the multiple second-level objects, in the cluster or sub-cluster.

10. The non-transitory computer-readable storage medium of claim 8, wherein generating and displaying the second UI view comprises:
generating and displaying the second UI view that includes multiple third UI elements representing respective multiple third-level objects associated with the particular second-level object, wherein the performance issue is associated with at least one of the multiple third-level objects.

11. The non-transitory computer-readable storage medium of claim 10, wherein generating and displaying the second UI view comprises:
generating and displaying the second UI view that includes multiple third UI elements representing the respective multiple third-level objects, wherein the multiple third-level objects include one or more of the following: a virtualized computing instance, a virtual tunnel endpoint (VTEP) and a logical network element supported by a host.

12. The non-transitory computer-readable storage medium of claim 8, wherein generating and displaying the second UI view comprises:
generating and displaying the second UI view that includes packet flow information identifying the performance issue in the form of one of the following packet flow metrics not satisfying a threshold: latency, jitter, packet loss and throughput.

13. The non-transitory computer-readable storage medium of claim 8, wherein generating and displaying the second UI view comprises:
generating and displaying the second UI view that includes connectivity information identifying the performance issue in the form of a connectivity loss caused by an unhealthy VTEP supported by a particular host, being the particular second-level object.

14. The non-transitory computer-readable storage medium of claim 8, wherein the method further comprises:
prior to generating and displaying the first UI view, generating and displaying a prior UI view that includes a zero-level status indicator indicating that a root-level object is associated with the performance issue based on the first-level object and the particular second-level object being associated with the performance issue.

15. A computer system, comprising:
a user interface (UI) module; and
a search service, wherein:
in response to receiving, from a client system via the UI module, a first query identifying a first-level object, the search service is to generate and send a first response to cause the client system to display a first UI view that includes:
(a) a first UI element to represent the first-level object, and multiple second UI elements to represent respective multiple second-level objects associated with the first-level object;
(b) a first-level status indicator to indicate that the first-level object is associated with a performance issue; and
(c) a second-level status indicator to indicate that the performance issue is associated with at least a particular second-level object from the multiple second-level objects;
in response to receiving, from the client system via the UI module, a second query identifying the particular second-level object, the search service is to generate and send a second response to cause the client system to display a second UI view that includes information identifying the performance issue associated with the particular second-level object to facilitate troubleshooting.

16. The computer system of claim 15, wherein the search service is to generate and send the first response by performing the following:
generate and send the first response to cause the client system to display the first UI view that includes the first UI element and the multiple second UI elements arranged in a hierarchy, wherein (a) the first UI element represents a cluster or sub-cluster, being the first-level object, and (b) the multiple second UI elements represent respective multiple hosts, being the multiple second-level objects, in the cluster or sub-cluster.

17. The computer system of claim 15, wherein the search service is to generate and send the second response by performing the following:
generate and send the second response to cause the client system to display the second UI view that includes multiple third UI elements representing respective multiple third-level objects associated with the particular second-level object, wherein the performance issue is associated with at least one of the multiple third-level objects.

18. The computer system of claim 17, wherein the search service is to generate and send the second response by performing the following:
generate and send the second response to cause the client system to display the second UI view that includes multiple third UI elements representing the respective multiple third-level objects, wherein the multiple third-level objects include one of the following: a virtualized computing instance, a virtual tunnel endpoint (VTEP) and a logical network element.

19. The computer system of claim 15, wherein the search service is to generate and send the second response by performing the following:
generate the second response to include packet flow information identifying the performance issue in the form of one of the following packet flow metrics not satisfying a threshold: latency, jitter, packet loss and throughput; and
send the second response to cause the client system to display the second UI view that includes the packet flow information.

20. The computer system of claim 15, wherein the search service is to generate and send the second response by performing the following:
generate the second response to include connectivity information identifying the performance issue in the form of a connectivity loss caused by an unhealthy VTEP supported by a particular host, being the particular second-level object; and
send the second response to cause the client system to display the second UI view that includes the connectivity information.

21. The computer system of claim 15, wherein the search service is further to:
prior to receiving the first query, generate and send a prior response to cause the client system to display a prior UI view that includes a zero-level status indicator indicating that a root-level object is associated with the performance issue based on the first-level object and the particular second-level object being associated with the performance issue.
